(19) United States
(12) Patent Application Publication
(10) Pub. No.: US 2024/0100933 A1
(43) Pub. Date: Mar. 28, 2024

(54) ELECTRIC POWERTRAIN AND METHODS OF RETROFITTING THEREOF

(71) Applicant: Wabash National, L.P., Lafayette, IN (US)

(72) Inventors: Mark Ehrlich, Lafayette, IN (US); Michael Bodey, Lafayette, IN (US)

(73) Assignee: Wabash National, L.P., Lafayette, IN (US)

(21) Appl. No.: 18/371,551

(22) Filed: Sep. 22, 2023

Related U.S. Application Data
(60) Provisional application No. 63/576,455, filed on Sep. 22, 2022.

(51) Int. Cl. B60K 6/445; B60K 6/26

(52) U.S. Cl. CPC B60K 6/445; B60K 6/26; B60K 2025/005

(57) ABSTRACT

The present disclosure relates to powertrains for a vehicle. In one embodiment, a driveline for a cargo vehicle is provided comprising a plurality of ground engaging members comprising a front left ground engaging member, a front right ground engaging member, a rear left ground engaging member and a rear right ground engaging member. The driveline also comprises a first motor and a first power source electrically coupled to the first motor. The driveline further comprises a non-driven axle coupled between the rear left ground engaging member and the rear right ground engaging member, a second motor operably coupled to the rear left ground engaging member and a third motor operably coupled to the rear right ground engaging member. Further, a second power source is electrically coupled to each of the second motor and the third motor.

### RELATED APPLICATIONS

The present application claims priority to U.S. Provisional Patent Application Ser. No. 63/576,455, filed Sep. 22, 2022, and entitled “ELECTRIC POWERTRAIN AND METHODS OF RETROFITTING THEREOF,” the complete disclosure of which is expressly incorporated by reference herein.

### FIELD OF THE DISCLOSURE

The present disclosure relates to powertrain configurations, methods of retrofitting and supplementing powertrain configurations, and methods of use thereof for a cargo vehicle.

### BACKGROUND OF THE DISCLOSURE

Delivery and cargo-transport vehicles often carry heavy cargo and, where such vehicles are electric or hybrid vehicles, additional weight or load is included on the vehicle in the form of motors and heavy batteries. Additionally, electric delivery vehicles often suffer from high power consumption during acceleration and, as such, the efficiency of the vehicle may be reduced.

### SUMMARY OF THE DISCLOSURE

The present disclosure provides a secondary powertrain assembly which may decrease the weight and increase the efficiency of a hybrid or electric cargo vehicle. In one embodiment, the secondary powertrain may be retrofitted to an existing hybrid or electric cargo vehicle and may be separate from but integrated for use with the existing powertrain assembly provided by the original equipment manufacturer (“OEM”).

In one embodiment, a driveline for a cargo vehicle is provided. The driveline comprises a plurality of ground engaging members comprising a front left ground engaging member, a front right ground engaging member, a rear left ground engaging member and a rear right ground engaging member. The driveline also comprises a first motor, a first power source electrically coupled to the first motor and a non-driven axle coupled between the rear left ground engaging member and the rear right ground engaging member. The driveline also comprises a second motor operably coupled to the rear left ground engaging member, a third motor operably coupled to the rear right ground engaging member, and a second power source electrically coupled to each of the second motor and the third motor.

The driveline further comprises a driven axle coupled between the front left ground engaging member and the front right ground engaging member, the first motor operably coupled to drive the driven axle. Additionally, a powered accessory electrically coupled to the second power source. In various embodiments, the first power source and the second power source are chemically distinct. In various embodiments, the driveline further comprises a controller communicably coupled to each of the first motor, the second motor, and the third motor. The controller is configured to provide instructions to operate the first motor when a first vehicle condition is satisfied, operate the second motor and third motor when a second vehicle condition is satisfied, and operate each of the first motor, second motor, and third motor when a third vehicle condition is satisfied. Additionally, the first vehicle condition is a first wheel speed, the second vehicle condition is a second wheel speed, and the third vehicle condition is a third wheel speed. In the present embodiment, the first wheel speed is greater than the third wheel speed, and the third wheel speed is greater than the second wheel speed.

In another embodiment of the present disclosure, a driveline for a cargo vehicle is provided. The driveline comprises a plurality of ground engaging members comprising a front left ground engaging member, a front right ground engaging member, a rear left ground engaging member and a rear right ground engaging member. The driveline further comprises a first motor configured to power each of the front left ground engaging member and the front right ground engaging member. Additionally, a first power source is electrically coupled to the first motor, a second motor is operably coupled to the rear left ground engaging member, and a third motor is operably coupled to the rear right ground engaging member. Further, an accessory system supported by the frame, and a second power source is supported by the frame. The second power source is electrically coupled to each of the second motor, the third motor and the accessory system.

In various embodiments, the second motor and third motor are hub motors. Further, the front left ground engaging member and the front right ground engaging members are coupled by a driven axle and the rear left ground engaging member and the rear right ground engaging member are coupled by a non-driven axle. In various embodiments, the driveline comprises a controller communicably coupled to each of the first motor, the second motor, and the third motor. The controller is configured to provide instructions to each of the first motor, second motor and the third motor, the instructions comprising operating the first motor after a first threshold value is reached and operating the second motor and the third motor before the first threshold value is reached. Additionally, the second motor and third motor are configured to provide greater torque than the first motor.

In various embodiments, the driveline comprises a controller communicably coupled to each of the first motor, the second motor, and the third motor. Further, the controller is configured to provide instructions to each of the first motor, second motor and the third motor, the instructions comprising operating only the second motor and the third motor during an acceleration vehicle event. In various embodiments, the first power source and the second power source are chemically distinct.

In another embodiment of the present disclosure, a method of retrofitting a cargo vehicle with a secondary powertrain is provided. The method comprises providing, at a first time, the cargo vehicle with a plurality of ground engaging members, a driven axle coupled between the a first ground engaging member of the plurality of ground engaging members and a second ground engaging member of the plurality of ground engaging members, and a non-driven axle coupled between a third ground engaging member of the plurality of ground engaging members and a fourth ground engaging member of the plurality of ground engaging members. The method further comprises providing a first motor operatively coupled to the driven axle, a first power source electrically coupled to the first motor, and a frame supported by the driven axle and the non-driven axle. The method further comprises providing, subsequent to the first time, a second motor to the cargo vehicle, providing, subsequent to the first time, a third motor to the cargo vehicle, providing, subsequent to the first time, a second power source electrically coupled to the second motor and the third motor, and providing, subsequent to the first time, a controller communicably coupled to each of the first motor, second motor, and third motor. The method further comprises coupling the second motor to the third ground engaging member and coupling the third motor to the fourth ground engaging member. In various embodiments, the method comprises providing an accessory system to the cargo vehicle, and electrically coupling, subsequent to the first time, the accessory system to the second power source. Further, the method comprises providing a controller communicably coupled to the first motor, communicably coupling, subsequent to the first time, the second motor and the controller, and communicably coupling, subsequent to the first time, the third motor and the controller. The controller is configured to operate the first motor when a first vehicle condition is satisfied and operate the second motor and third motor when a second vehicle condition is satisfied. The controller is further configured to operate each of the first motor, second motor, and third motor when a third vehicle condition is satisfied.

In various embodiments, the first motor is an electric motor, the second motor is a hub motor, and the third motor is a hub motor. In various embodiments, the second power source and the first power source are chemically distinct. In various embodiments, the first motor is an internal combustion engine and the second motor is a hub motor and the third motor is a hub motor.

### BRIEF DESCRIPTION OF THE DRAWINGS

FIG. 1A is a left side view of a cargo vehicle of the present disclosure;

FIG. 1B is a cross-section view of a panel of the cargo vehicle of FIG. 1;

FIG. 2 is a schematic view of a powertrain layout for the vehicle of the present disclosure;

FIG. 3 is a schematic view of a retrofitted powertrain layout for the vehicle of the present disclosure;

FIG. 4 is a schematic view of an alternate retrofitted powertrain layout for the vehicle of the present disclosure;

FIG. 5 is a control diagram of the retrofitted powertrain of FIG. 3;

FIG. 6 is a control diagram of the retrofitted powertrain of FIG. 4;

FIG. 7 is a representative transition graph for the powertrain of the present disclosure;

FIG. 8 is a left side view of a cargo vehicle of the present disclosure;

FIG. 9 is a representative transition graph for the powertrain of the present disclosure; and

FIG. 10 is a control diagram for use with the cargo vehicle of the present disclosure.

### DETAILED DESCRIPTION OF THE DRAWINGS

For the purposes of promoting an understanding of the principles of the present disclosure, reference is now made to the embodiments illustrated in the drawings, which are described below. The embodiments disclosed below are not intended to be exhaustive or limit the present disclosure to the precise form disclosed in the following detailed description. Rather, the embodiments are chosen and described so that others skilled in the art may utilize their teachings. Therefore, no limitation of the scope of the present disclosure is thereby intended. Corresponding reference characters indicate corresponding parts throughout the several views.

The terms “couples”, “coupled”, “coupler”, and variations thereof are used to include both arrangements wherein two or more components are in direct physical contact and arrangements wherein the two or more components are not in direct contact with each other (e.g., the components are “coupled” via at least a third component, but yet still cooperates or interact with each other).

In some instances throughout this disclosure and in the claims, numeric terminology, such as first, second, third, and fourth, is used in reference to various operative transmission components and other components and features. Such use is not intended to denote an ordering of the components. Rather, numeric terminology is used to assist the reader in identifying the component being referenced and should not be narrowly interpreted as providing a specific order of components.

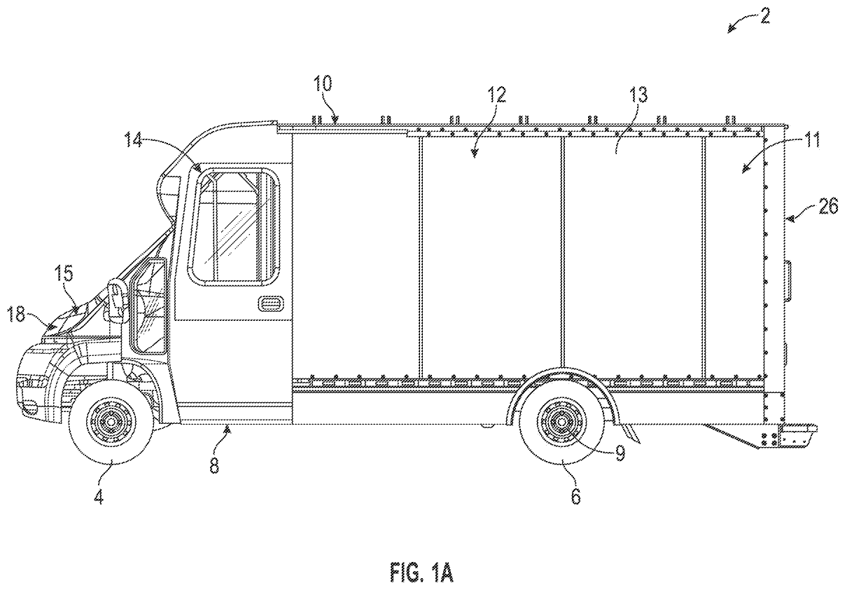

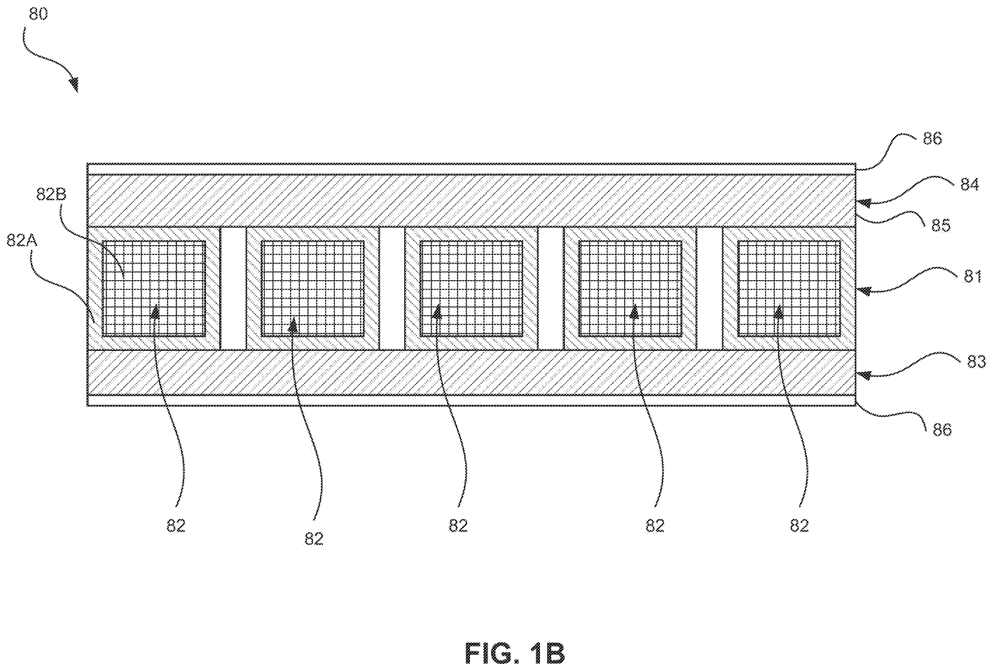

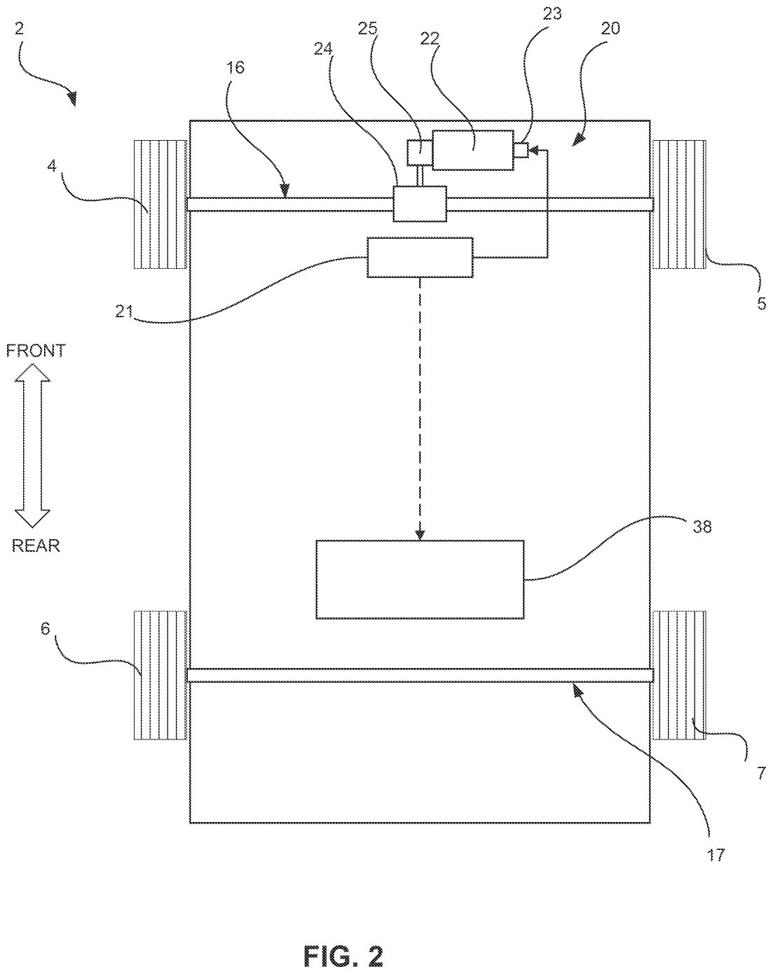

Referring now to FIG. 1A, a delivery or cargo-transport vehicle 2 is provided. Vehicle 2 may be a delivery van, a dry truck body trailer, a refrigerated van, truck body, or trailer, a flat bed trailer, or any other type of trailer, cargo van, or cargo vehicle. Vehicle 2 comprises a plurality of ground engaging members including a front left ground engaging member 4, a front right ground engaging member 5 (FIG. 2), a rear left ground engaging member 6, and a rear right ground engaging member 7 (FIG. 2). In various embodiments, vehicle 2 comprises additional ground engaging members positioned rearward of front ground engaging members 4, 5. A frame 8 is supported by the ground engaging members 4, 5, 6, 7 and is configured to support a body 12. Body 12 comprises a plurality of panels 13 configured to surround a cargo or box portion 11. Box portion 11 is configured to stow, protect and support cargo. Illustratively, box portion 11 includes opposing side walls 13 on right and left sides of vehicle 2, a rear door 26, a floor (not shown) coupled to frame 8, a roof 10, and a front or nose wall coupled to side walls 13 and positioned generally opposite rear door 26. Any of the walls or portions of box portion 11 may be comprised of singular panels or a plurality of panels integrally or removably coupled together.

The panels may be comprised of metallic, wood, and/or foam materials, as discussed in any of U.S. patent application Ser. No. 15/550,366, filed Feb. 23, 2016, titled COMPOSITE REFRIGERATED TRUCK BODY AND METHOD OF MAKING THE SAME, issued on Mar. 24, 2020 as U.S. Pat. No. 10,596,950; U.S. patent application Ser. No. 15/299,810, filed Oct. 21, 2016, titled EXTRUDED MOLDS AND METHODS FOR MANUFACTURING COMPOSITE TRUCK PANELS, issued on Jan. 21, 2020 as U.S. Pat. No. 10,538,051; U.S. patent application Ser. No. 15/438,667, filed Feb. 21, 2017, titled COMPOSITE REFRIGERATED SEMI-TRAILER AND METHOD OF MAKING THE SAME, issued on Nov. 19, 2019 as U.S. Pat. No. 10,479,419; U.S. patent application Ser. No. 15/437,290, filed Feb. 20, 2017, titled COMPOSITE FLOOR FOR A DRY TRUCK BODY, issued on Mar. 26, 2019 as U.S. Pat. No. 10,239,566; U.S. patent application Ser. No. 15/439,662, filed Feb. 22, 2017, titled COMPOSITE FLOOR STRUCTURE AND METHOD OF MAKING THE SAME, issued on Jun. 25, 2019 as U.S. Pat. No. 10,329,763; U.S. patent application Ser. No. 16/189,026, filed Nov. 13, 2018, titled COMPOSITE STRUCTURAL PANEL AND METHOD OF FABRICATION, issued on Nov. 5, 2019 as U.S. Pat. No. 10,465,348; U.S. application Ser. No. 16/363,089, filed Mar. 25, 2019, titled STRUCTURAL COMPOSITE PREFORM WET-OUT AND CURING SYSTEM AND METHOD, attorney docket no. “WNC-2019-06-01-US”; U.S. application Ser. No. 17/019,605, filed Sep. 14, 2020, titled COMPOSITE STRUCTURE WITH MOLDED-IN WOOD SURFACE, published on Mar. 25, 2021 as U.S. Publication No. 2021/0086483A1, the entire disclosures of which are expressly incorporated by reference herein. In one embodiment, the panels do not include any wood or metallic layers and, instead, may be generally comprised of a foam core, at least one layer or liner of a polymeric material such as a fiber-reinforced material, and an inner and/or outer coating such as a polymeric gel coat material. In such embodiments, the polymeric construction of the panels may be sufficiently rigid and meet structural requirements so as to eliminate the need for any metallic or wood materials therein. As a result of this construction, the overall weight of box portion 11 may be reduced.

Vehicle 2 is generally greater in weight than a passenger vehicle (e.g., passenger car or sedan) or a passenger truck (e.g., mid-size or full-size pick-up truck) in order to support more cargo and more weight than a passenger vehicle or a passenger truck. Vehicle 2 may have a Gross Vehicle Weight (GVW) in excess of 10,000 pounds, 15,000 pounds, 20,000 pounds, or more. The weight of vehicle 2 may require a powertrain suited for both propelling a higher weight vehicle from a standstill (e.g., 0 miles per hour (mph)) as well as maintaining propulsion at high speeds (e.g., 50 mph or more), while maintaining high energy efficiency at low speeds and high speeds. The variable weight of payloads may benefit from a variable multi-solution powertrain capable of operating between light-payload, low-speed and high-payload, high-speed applications.

Referring to FIG. 1B, an example panel composition is provided. A cross section composition 80 is provided, comprising a core or first layer 81, an outer or second layer 83, and an inner or third layer 84. Core layer 81 may be comprised of a plurality of beams 82 which may comprise a plurality of beam portions or layers, illustratively layers 82A, 82B. Layers 82A, 82B may be homogenous or may be comprised of multiple materials. In the present embodiment, beams 82 are preforms, and exemplary beams 82 include PRISMA® preforms provided by Compsys, Inc. of Melbourne, Florida. Any of layers 82A, 82B may be made of a foam material, a Fiber-Reinforced Polymer (FRP), and/or a polymer matrix reinforced with fibers to enhance the structural properties of the surrounding polymer matrix. Suitable reinforcing fibers include glass fibers, carbon fibers, aramid fibers (e.g., Kevlar® fibers available from DuPont Protection Technologies of Richmond, Virginia), linear polyethylene or polypropylene fibers (e.g., Sepctra® fibers available from Honeywell International Inc. of Morris Plains, New Jersey), or polyester fibers.

Illustratively, core layer 81 comprises a plurality of beams 82 spaced apart from one another. In various embodiments, a supporting material is provided intermediate beams 82 to increase the support intermediate beams 82. Supporting material may include foam, a curable resin, or another material. In various embodiments, each of beams 82 are directly contacting each other and configured to provide support to adjacent beams 82.

Outer layer 83 and inner layer 84 may be made of an FRP material similar to beams 82. In various embodiments, outer layer 83 and inner layer 84 may be comprised of multiple materials in a stacked or embedded configuration or from a single homogenous material. In various embodiments, outer layer 83 and inner layer 84 are made of or include a polymeric gel coating layer or another liner material.

In one example, inner layer 84 may be comprised of a first layer 85, such as an FRP material layer, and a second outer layer 86 that is inwardly facing. Second outer layer 86 may be configured with a suitable coating with a textured surface for enhancing grip, a suitable surface for refracting light, or otherwise configured for various applications. As shown in FIG. 1B, outer layer 86 is positioned adjacent layer 85. In various embodiments, an outer layer 86 is provided adjacent outer layer 83, facing outwardly. Outer layer 86 is configured to cover and conceal outer layer 83. In various embodiments, cross section 80 comprises an outer layer 86 on either side, both sides, or neither side of cross section 80.

Referring again to FIG. 1, vehicle 2 also comprises a cab or operator portion 15 supported by frame 8 and positioned forward of box portion 11. Cab portion 15 generally comprises a door 14 configured to allow ingress and egress of a driver and/or passenger of vehicle 2. Front portion 15 also comprises a portion of body 12, including a hood 18, which may conceal at least a portion of a powertrain assembly of vehicle 2, as disclosed further herein.

Referring now to FIG. 2, vehicle 2 comprises a driven axle 16 and a non-driven axle 17. In the present embodiment, driven axle 16 is coupled between front left ground engaging member 4 and front right ground engaging member 5, and the non-driven axle 17 is coupled between rear left ground engaging member 6 and rear right ground engaging member 7. That is, driven axle 16 is the front axle and non-driven axle 17 is the rear axle. In the present embodiment, driven axle 16 is operatively coupled to a first powertrain 20. In various embodiments, driven axle 16 is the rear axle and non-driven axle 17 is the front axle. First powertrain 20 may include a combustion engine, a motor and at least one battery in an electric powertrain configuration, or may be a hybrid powertrain configuration.

In the present embodiment, first powertrain 20 is an electric powertrain comprising a first power source, or primary power source 21 and a first motor 22. First power source 21 may be a battery, an ultra-capacitor, or another type of energy source configured for discharging electrical power. First power source 21 is electrically coupled to first motor 22 and configured to provide electrical power to first motor 22. First powertrain 20 also comprises a motor controller 23 electrically coupled to first power source 21 and first motor 22. In the present embodiment, motor controller 23 is integral to first motor 22. In various embodiments, motor controller 23 is a physically separated component from first motor 22. First motor 22 is operatively coupled to driven axle 16 by a drive member 24 and a shiftable transmission 25. In the present embodiment, shiftable transmission 25 is coupled to first motor 22 and configured to receive a rotational input from a motor output (not shown), alter the rotational input speed and/or direction through a geartrain (not shown) and output the rotational input as a rotational output to front drive member 24. Drive member 24 is coupled between transmission 25 and driven axle 16. In the present embodiment, drive member 24 is a differential configured to receive the rotational output from shiftable transmission 25 and provide a rotational output to each of front left ground engaging member 4 and front right ground engaging member 5. In various embodiments, drive member 24 is an open differential, a locked differential, an electronic locking differential, or another type of differential. In various embodiments, first powertrain 20 does not have a shiftable transmission 25, and first motor 22 is directly coupled to drive member 24.

Still referring to FIG. 2, in various embodiments, vehicle 2 is assembled at a first time, at its Original Equipment Manufacturer (“OEM”), with only a single driven axle 16 as shown in FIG. 2. That is, when assembled by the OEM, vehicle 2 has a single driven axle 16 as either a front axle or a rear axle, and the other of the front axle or the rear axle is a non-driven axle making vehicle 2 a Two-Wheel Drive (2WD) vehicle.

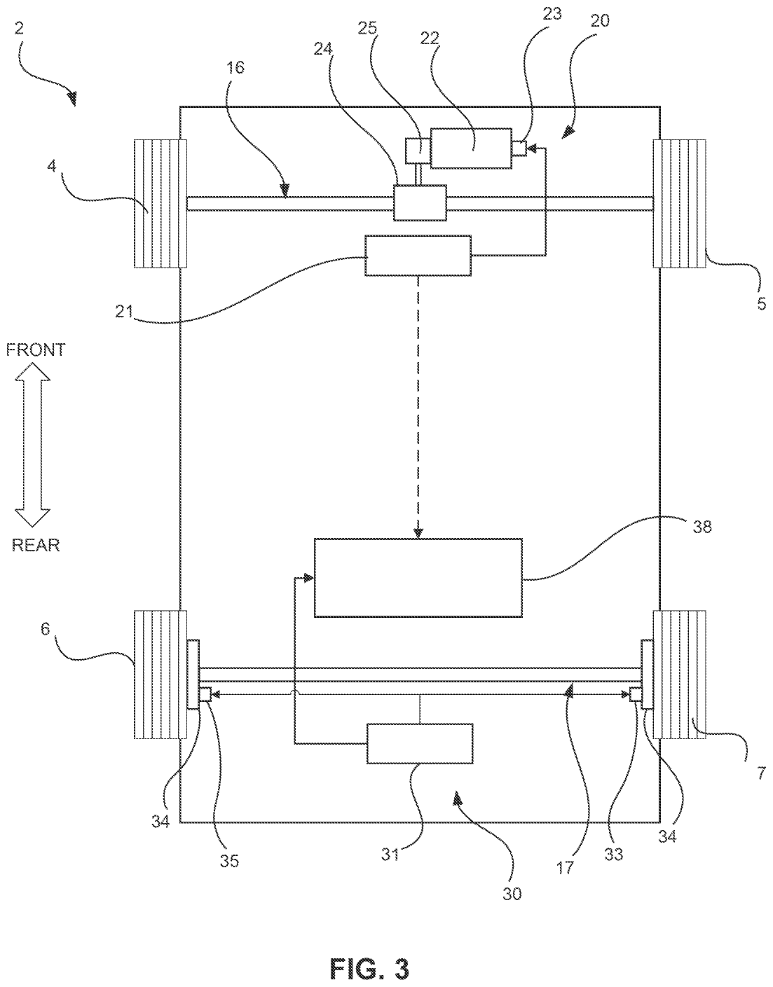

In the present embodiment, referring now to FIG. 3, a second powertrain 30 may be provided on vehicle 2. In one embodiment, second powertrain 30 may be retrofitted onto non-driven axle 17 of vehicle 2 at a second time, subsequent to the first time (i.e., the time of installation of first powertrain 20 by the OEM). Second powertrain 30 also may be an electric powertrain comprising a second power source 31. Second power source 31 may be a battery, an ultra-capacitor, or another type of energy source configured for discharging electrical power. Second powertrain 30 also comprises at least one motor and, illustratively, may comprise both a second motor 32 and a third motor 34. In the present embodiment, each of second motor 32 and third motor 34 may be hub motors configured to couple to ground engaging members 6, 7. Hub motors 32, 34 may be retrofitted onto vehicle 2 at the second time. In the present embodiment, hub motors 32, 34 are configured to fit within, and be supported by, the wheel of the corresponding ground engaging member 6, 7. In the present embodiment, hub motors 32, 34 are fixedly coupled to non-driven axle 17 and, when an electric current is pushed through hub motors 32, 34, ground engaging members 6, 7 rotate relative to non-drive axle 17.

In various embodiments of the present disclosure, each ground engaging member 6, 7 has a hub 9 (FIG. 1) comprising a bearing (not shown) configured to facilitate the rotation of ground engaging member 6, 7 relative to the non-driven axle 17. During a retrofit of vehicle 2, hubs 9, which may be provided by the OEM, may be removed from ground engaging members 6, 7 and are replaced by hub motors 32, 34. This makes for an easy retrofit of vehicle 2 from having a single motor 22 to up to three motors 22, 32, 34, thereby making vehicle 2 capable of Four-Wheel Drive (4WD).

Still referring to FIG. 3, second motor 32 is configured to be coupled to non-driven axle 17 and ground engaging member 7 and third motor 34 is configured to be coupled to non-driven axle 17 and ground engaging member 6. In the present embodiment, second power source 31 is electrically coupled to each of second motor 32 and third motor 34. Second powertrain 30 also comprises at least one motor controller operably coupled to second power source 31 and motors 32, 34. For example, as shown in FIG. 3, second powertrain 30 comprises a motor controller 33 electrically coupled to second power source 31 and second motor 32 and a motor controller 35 electrically coupled between second power source 31 and third motor 34. In various embodiments, motor controller 33 is integral with second motor 32. In various embodiments, motor controller 35 is integral with third motor 34. In various embodiments, either of, or both of, motor controllers, 33, 35 are separated from second motor 32 and third motor 34, respectively. In further embodiments, both motors 32, 34 may be controlled by a single motor controller.

Vehicle 2 may also comprise a powered accessory or accessory system 38. In various embodiments, powered accessory is operably coupled to body 12 and/or box 11. In the present embodiment, powered accessory 38 may be a refrigeration unit, a heating unit, an air conditioning unit, a humidity controlling unit, or another type of powered accessory commonly used with vehicle 2. Powered accessory 38 comprises an electrical input (not shown) configured to receive electrical power. In the present embodiment, powered accessory 38 receives electrical power at the electrical input from second power source 31 and uses the electrical power to operate the powered accessory (e.g., refrigerating deliverables). In various embodiments, powered accessory 38 may receive electrical power at the electrical input from first power source 21. In various embodiments, powered accessory 38 may be configured to receive electrical power at the electrical input from either of, or both of, first power source 21 or second power source 31.

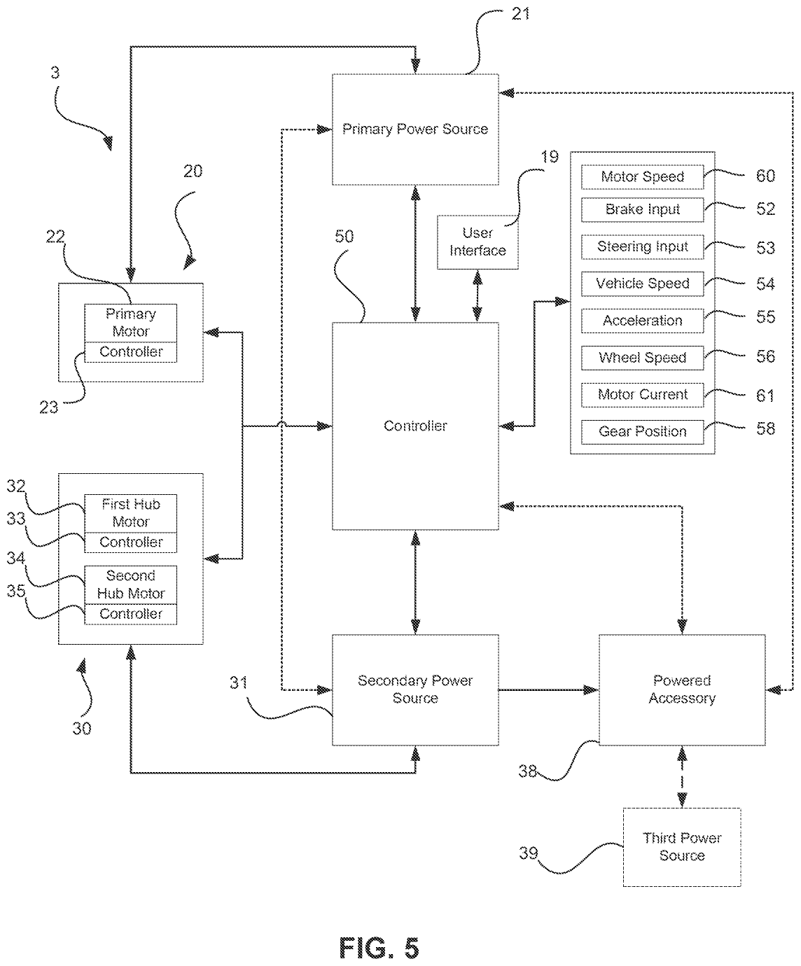

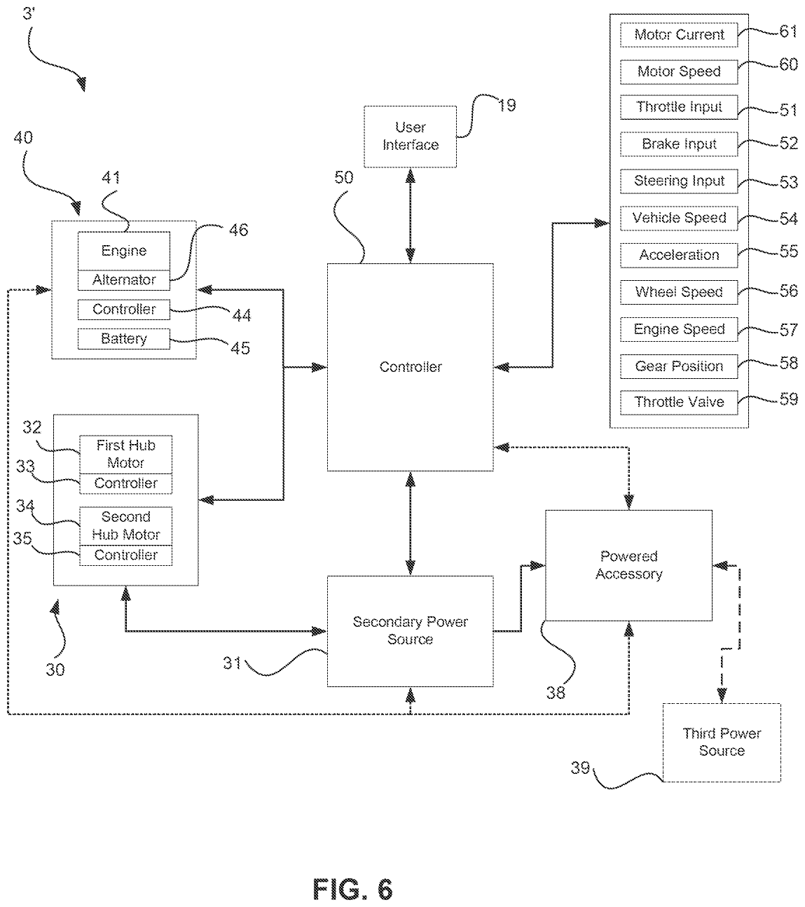

In various embodiments, vehicle 2 comprises a third power source 39 (FIGS. 5 and 6) configured to provide electrical power to powered accessory 38.

Still referring to FIG. 3, in the present embodiment, first power source 21 and second power source 31 are both batteries. In the present embodiment, first power source 21 is a lithium-ion battery or a hydrogen fuel cell. In the present embodiment, second power source 31 is a lithium-ion phosphate battery or a Nickel-Metal-Cadmium battery. In the present embodiment, first power source 21 and second power source 31 are chemically distinct. That is, in the present embodiment, each of first power source 21 and second power source 31 has a distinct combination of an anode, cathode, and/or electrolyte and first and second power sources 21, 31 may be chemically distinct from each other.

Vehicle 2 is originally assembled by the OEM to be a 2WD vehicle and, as such, first power source 21 is often configured at the OEM with chemical properties and composition to optimally discharge during a particular vehicle operating state (e.g., acceleration, steady-state, etc.). In this way, first power source 21 may not be configured to discharge optimally across multiple vehicle operating states. In other words, first power source 21 may be configured for optimal discharge when vehicle 2 is operating in a steady state (e.g., operating at a consistent speed across a flat surface) but may not be configured for optimal discharge when vehicle 2 is under an increased load, such as when vehicle 2 is accelerating or operating on inclined or uneven terrain. As may be appreciated, acceleration optimization requires a high amount of torque, and therefore, a large current discharge, while steady-state optimization requires less torque, but often larger capacity or voltage output for maintaining constant speed on a highway. In the present embodiment, by retrofitting vehicle 2 at the second time after assembly at the OEM at the first time, second power source 31 may be configured with different chemical properties and/or composition than first power source 21 and each of first power source 21 and second power source 31 may be optimized for specific vehicle operating states. In the present embodiment, first power source 21 is optimized for a steady-state operation. That is, first power source 21 is a battery configured to maximize and/or optimize vehicle use or performance during a steady-state situation on a highway, often requiring higher voltage output to maintain speed. In the present embodiment, second power source 31 is optimized for an acceleration operating event. That is, second power source 31 is a battery configured to maximize and/or optimize vehicle use during an acceleration state, often requiring higher current to increase torque.

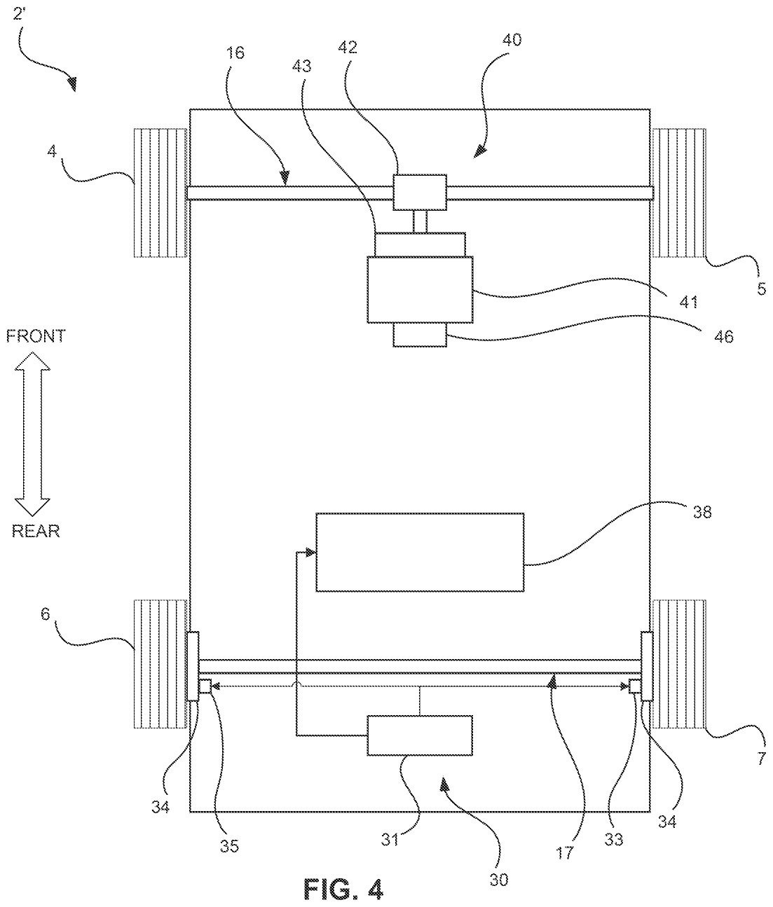

Now referring to FIG. 4, an alternate powertrain arrangement is provided in a vehicle 2′. Vehicle 2′ comprises an alternative embodiment to powertrain 20, which is shown as powertrain 40, and powertrain 30. Powertrain 40 comprises an engine 41 operably coupled to driven axle 16. Engine 41 is an internal combustion engine (ICE) and may be gasoline powered, diesel powered, or may be powered by another type of fuel. Engine 41 generally comprises an intake (not shown), an exhaust (not shown), a fuel tank (not shown) configured to provide fuel to the intake, and a plurality of cylinders (not shown) positioned within a crankcase (not shown) and operably coupled to a crankshaft (not shown) configured to provide rotational power to driven axle 16. Powertrain 40 also comprises a shiftable transmission 43 operably coupled to engine 41 and a drive member 42. Shiftable transmission 43 may comprise a plurality of gear members (not shown) configured to alter the rotational speed between an engine output (not shown) of engine 41 and a drive member input (not shown) of drive member 42. Shiftable transmission 43 may also be configured to reverse the rotational direction of the engine output of engine 41. Drive member 42 is coupled between transmission 43 and driven axle 16 and may be a differential configured to receive a rotational input from shiftable transmission 43 and provide a rotational output to each of front left ground engaging member 4 and front right ground engaging member 5. In various embodiments, drive member 42 is an open differential, a locked differential, an electronic locking differential, or another type of differential.

Powertrain 40 also comprises an alternator 46, a controller 44 and a battery 45. Alternator 46 is drivingly coupled to engine 41 such that a rotation of the crankshaft (not shown) of engine 41 operates alternator 46 to create electrical power. In the present embodiment, battery 45 is a low-voltage battery (e.g., 12V or 24V) configured to provide low voltage power to a starter, various sensors, and other components of powertrain 40. In various embodiments, battery 45 is electrically coupled to secondary power source 31 such that secondary power source 31 may charge battery 45 through a DC/DC converter (not shown) in the event of a failure of alternator 46. Further, alternator 46 may also be electrically coupled to one of, or each of, secondary power source 31 and powered accessory 38 so that alternator 46 could charge and/or provide power to secondary power source 31 and powered accessory 38. In various embodiments, a DC/DC converter (not shown) is present between alternator 46 and secondary power source 31 or powered accessory 38 to match a required voltage level.

With the configuration of powertrain 40, as disclosed herein, and second powertrain 30, as previously described, vehicle 2′ may be configured as a hybrid vehicle. That is, vehicle 2′ comprises an internal combustion engine configured to drive a first set of ground engaging members (i.e., front left ground engaging member 4 and front right ground engaging member 5) and an electric powertrain configured drive a second set of ground engaging members (i.e., rear left ground engaging member 6 and rear right ground engaging member 7). Vehicle 2′ also may comprise powered accessory 38 electrically coupled to second power source 31. In various embodiments, powertrain 40 is coupled to rear axle 17 and second powertrain 30 is coupled to front axle 16.

Still referring to FIG. 4, in various embodiments, vehicle 2′ is assembled by an OEM at the first time to have powertrain 40. At the second time subsequent to the first time, vehicle 2′ can be retrofitted with second powertrain 30. That is, when vehicle 2′ is retrofitted, second motor 32 is coupled between non-driven axle 17 and rear right ground engaging member 7 and third motor 34 is coupled between non-driven axle 17 and rear left ground engaging member 6. Vehicle 2′ will then, at the second time, have powertrain 40 with engine 41 providing power to the driven axle 16 and the second powertrain 30 providing power to the ground engaging members coupled to the non-driven axle 17.

For either of vehicle 2 or vehicle 2′, powertrains 20, 30, 40 may be sized according to various purposes to propel vehicle 2, 2′ during different scenarios. As previously discussed, vehicle 2, 2′, weighs more than a standard passenger vehicle, and therefore requires different power considerations than a standard passenger vehicle. For example, vehicle 2, 2′ comprises two separate powertrains (e.g., vehicle 2 comprises powertrains 20, 30 and vehicle 2′ comprises powertrains 40, 30) where the first powertrain (e.g., powertrain 20 or powertrain 40) may be configured to output a first torque and the second powertrain (e.g., powertrain 30) may be configured to output a second torque different than the first torque. Further, the first powertrain (e.g., powertrain 20 or powertrain 40) may be configured to output a first top speed and the second powertrain (e.g., powertrain 30) may be configured to output a second top speed different than the first top speed. In embodiments, the first powertrain may be configured to operate according to a higher torque than the second powertrain, and the first powertrain may be configured to operate at a standstill and lower speeds so that vehicle 2, 2′, may be propelled from a standstill more easily with the higher torque. Further, the first powertrain may be configured to operate according to a lower top speed than the second powertrain, and the second powertrain may be configured to operate at higher speeds so that vehicle 2, 2′, may more easily be propelled at higher speeds.

Referring now to FIG. 5, a control diagram 3 is provided. Control diagram 3 illustrates a controls layout for vehicle 2. Control diagram 3 comprises a controller 50 communicably coupled to first powertrain 20 and second powertrain 30. In the present embodiment, controller 50 is configured to send instructions to each of motor controller 23, motor controller 33, and motor controller 35, and the instructions may include a motor characteristic. Exemplary motor characteristics include a motor current (A) 61, a motor voltage (V), a motor speed (RPM) 60, a motor torque (Nm), a motor acceleration (RPM/s), or other motor characteristics. While the units herein are provided, it should be appreciated that any suitable units—metric, imperial, or other—may be used. Controller 50 is operably coupled to each of primary power source 21 and secondary power source 31. Controller 50 is configured to determine a current voltage (V) level of each of first power source 21 and second power source 31, as well as a total power level of each of first power source 21 and second power source 31. Controller 50 is also communicably coupled to powered accessory 38 and is configured to send instructions to powered accessory 38. Instructions to powered accessory 38 may include power characteristic such as a powered on/powered off state, a pulse width modulation (PWM) command, a required voltage (V) level, a required current (A) level, or another instruction.

First power source 21 is electrically coupled to motor controller 23 which is configured to monitor and control the amount of power being supplied to motor 22 from first power source 21. Second power source 31 is electrically coupled to each of motor controller 33 and motor controller 35, which are each configured to monitor and control the amount of power being supplied to motors 32, 34, respectively, from second power source 31. Secondary power source 31 is also electrically coupled to powered accessory 38. In the present embodiment, secondary power source 31 is the primary means to power powered accessory 38. In various embodiments, first power source 21 is also electrically coupled to, and provides power to, powered accessory 38.

Controller 50 is also communicably coupled to a plurality of vehicle sensors configured to provide information about vehicle 2. In the present embodiment, controller 50 is configured to receive a throttle input 51, a brake input 52, a steering input 53, a vehicle speed 54, an acceleration 55, a wheel speed 56, a motor speed 60, a gear position 58, and a motor current 61. In various embodiments, throttle input 51 is determined by a throttle angle sensor, a throttle position sensor, a discrete throttle input sensor, or another representative throttle input sensor. In various embodiments, brake input 52 is determined by a discrete brake input sensor, a brake angle sensor, or another representative brake input sensor. In various embodiments, vehicle speed 54 and acceleration 55 are determined by an accelerometer, a GPS unit, or an IMU. In various embodiments, a wheel speed 56 is provided by a wheel speed sensor positioned on any of, or all of ground engaging members 4, 5, 6, 7, a gear speed sensor positioned within or adjacent drive member 24, or a visual sensor and a toner ring positioned along driven axle 16 or any of ground engaging members 4, 5, 6, 7. In various embodiments, motor speed 57 is determined by an motor speed sensor positioned within any of, or all of, motors 22, 32, 34. In various embodiments, gear position 58 is determined by a gear position sensor coupled to, or adjacent, shiftable transmission 25. Controller 50 is also operably coupled to a user interface 19 that may be positioned within vehicle 2. User interface 19 is configured to receive a user input from an operator of vehicle 2. User interface may be a touch display or may otherwise be configured with a plurality of inputs such as sliders, knobs, buttons, switches, radio buttons, or the like.

Now referring to FIG. 6, a control diagram 3′ is provided illustrating a controls layout for vehicle 2′. Controller 50 is communicably coupled to second powertrain 30 and third powertrain 40. In control diagram 3′, controller 50 is configured to provide instructions to motor controller 33 and motor controller 35 for controlling motors 32, 34, respectively.

In the present embodiment, regarding vehicle 2, 2′, first powertrain 20, 40 and second powertrain 30 may be configured to operate independently of each other based on different vehicle events. That is, as previously described, first powertrain 20, 40 is configured to operate at steady-state and second powertrain 30 is configured to operate during acceleration events. In the present embodiment, second powertrain 30 is configured to provide the motive force to vehicle 2, 2′ when vehicle speed 54 is below a first threshold, and first powertrain 20, 40 is configured provide the motive force to vehicle 2, 2′ when vehicle speed 54 is above the first threshold. In the present embodiment, the first threshold may be 35 miles per hour (MPH). That is, vehicle 2, 2′ is configured to operate using second powertrain 30 between 0-35 MPH and is configured, by instructions from controller 50, to transition to operate using first powertrain 20, 40 at 35+ MPH. Further, if vehicle 2, 2′ is traveling at a vehicle speed 54 greater than the first threshold and vehicle speed 54 drops below the first threshold, controller 50 provides instructions to each of second powertrain 30 and first powertrain 20, 40 to transition from operating vehicle 2, 2′ using first powertrain 20, 40 to operating vehicle 2, 2′ using second powertrain 30.

Still referring to FIG. 6, in control diagram 3′, controller is communicably coupled to receive a plurality of values, including throttle input 51, brake input 52, steering input 53, vehicle speed 54, acceleration 55, wheel speed 56, engine speed 57, gear position 58, throttle valve position 59, motor speed 60, and motor current 61. In addition to the various methods of sensor value determination previously described, throttle valve input 59 is determined by a throttle valve angle sensor, a discrete throttle valve sensor, or another sensor, and engine speed 57 is determined by an engine speed sensor positioned on or within engine 41.

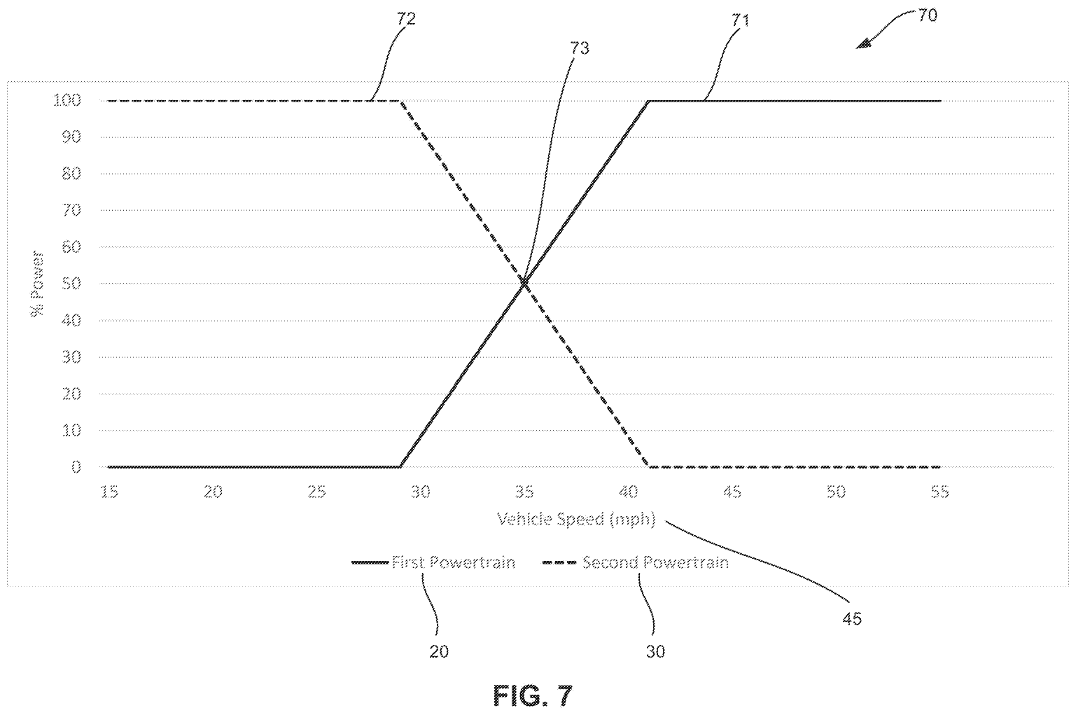

Referring to FIG. 7, while first powertrain 20, 40 is configured for independent operation from second powertrain 30, there may be overlapping operation of powertrains 20, 30, 40, via motor controller 50, based on various operating and threshold conditions. The transition in operation between first powertrain 20, 40 and second powertrain 30 is blended to create a smooth transition between operation of first powertrain 20, 40 and second powertrain 30, as shown in graph 70. That is, as vehicle speed 54 is increased, second powertrain 30 (e.g., line 72) provides the majority of the motive force to vehicle 2, 2′ between 0-35 MPH and continues to provide a minority of the power to vehicle 2, 2′ from 35-40 MPH, at which point, the power provided by second powertrain 30 steadily declines between 35-40 MPH. Further, as vehicle speed 54 is increased, first powertrain 20, 40 (e.g., line 71) provides no motive force between 0-30 MPH. First powertrain 20, 40 starts providing motive force to vehicle 2, 2′ at 30 MPH and provides the minority of the power between 30-35 MPH. At 35 MPH, an equilibrium point 73 is provided where first powertrain 20, 40 provides the same percentage of the power as second powertrain 30. Between 35-40 MPH, first powertrain 20, 40 is the majority power provider, and at 40+ MPH, first powertrain 20, 40 provides the entirety of the power to vehicle 2, 2′.

In the present embodiment, the speed at which first powertrain 20, 40 starts to provide power (e.g., approximately 30 MPH) is a second threshold, the speed at which the equilibrium point 73 is reached (e.g., approximately 35 MPH) is the first threshold, and the speed at which first powertrain 20, 40 provides all of the power (e.g., approximately 40 MPH) is a third threshold. In various embodiments, the first threshold, second threshold, and third threshold may be modified by an operator of vehicle 2, 2′ through an input to user interface 19. In one example, the thresholds may be modified based upon power capacity of either first power source 21, second power source 31, or the power source of powertrain 40 (e.g., fuel level).

In the present embodiment, it is desired to have second powertrain 30 provide the primary motive force at lower speeds than first powertrain 20, 40 (i.e., during acceleration from 0 MPH) because second powertrain 30 is able to provide a greater amount of torque than first powertrain 20, 40. In various embodiments, the threshold values may be altered so that either powertrain 20/40, 30 can provide the initial motive force depending upon which powertrain 20/40, 30 can provide the greater amount of torque.

Further, with respect to vehicle 2′ specifically, graph 70 of FIG. 7 indicates that engine 41 may start providing motive force at the second threshold (e.g., 30 MPH), provide an equal motive force as the second powertrain 30 at equilibrium point 73, or first threshold (e.g., 40 MPH), and provide all of the motive force at the third threshold (e.g., 45 MPH). In various embodiments, first threshold, second threshold, and third threshold are different for vehicle 2′ and vehicle 2.

In various embodiments, the first threshold (i.e., equilibrium point 73), second threshold, and third threshold are determined based upon wheel speed 56, acceleration 55, or another vehicle condition value.

In various embodiments, controller 50 is configured to provide the instructions to each of motor controller 23, 33, 35 and the engine controller 44 to control the amount of power provided from motors 22, 32, 34, and engine 41, respectively.

The present disclosure provides ability to optimize the size and performance power source 31 and power source 21 for specific performance characteristics and uses of vehicle 2, 2′. That is, because power sources 21, 31 can be configured to perform optimally under various vehicle operating states, the overall size and weight of power sources 21, 31 (i.e., batteries) can be optimized also, often resulting in the size and weight of power sources 21, 31 being reduced. Such a weight reduction on vehicle 2, 2′ may increase the overall vehicle performance during acceleration and braking and the overall range of vehicle 2, 2′ for a given amount of power capacity in power source 21, 31.

In various embodiments, controller 50 is configured to issue a torque correction between second motor 32 and third motor 34. Motors 32, 34 are not mechanically linked to maintain synchronicity, and therefore a torque or speed correction may be necessary. Controller 50 is configured to receive an input from either of motors 32, 34 or motor controllers 33, 35 with the current torque or speed output. To ensure a consistent torque or speed output among motors 32, 34, controller 50 may be configured to utilize a closed-loop feedback circuit with a target reference torque or reference speed. Each of motors 32, 34 is monitored and the output torque or output speed of motors 32, 34 is adjusted to match the target reference torque or reference speed.

In various embodiments, if either first powertrain 20, 40 or second powertrain 30 experiences a failure event, the other of first powertrain 20, 40 or second powertrain 30 is able to remain operational and provide full motive force to vehicle 2, 2′ for at least a period of time. That is, controller 50 will detect the failure and send instructions to the functional powertrain to operate.

In various embodiments, an operator may provide a user input to vehicle 2, 2′ (e.g., at user interface 19) to indicate a desire to provide power to all ground engaging members 4, 5, 6, 7. Controller 50 may then, subsequently, provide instructions to each of motors 22, 32, 34 of vehicle 2, or engine 41 and motors 32, 34 of vehicle 2′ to provide simultaneous power. In the event vehicle 2, 2′ is stuck or requires extra power, providing power to all ground engaging members 4, 5, 6, 7 may be useful.

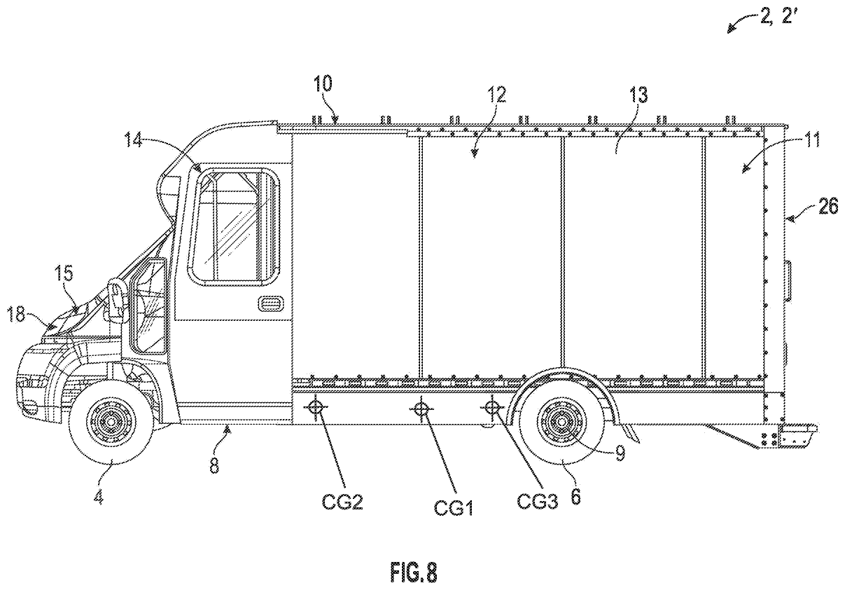

Referring now to FIG. 8, vehicle 2, 2′ may have a Center of Gravity (CG) positioned longitudinally intermediate ground engaging members 4, 5 and ground engaging members 6, 7. For example, vehicle 2 may have a Center of Gravity at CG1. In embodiments, Center of Gravity may shift depending upon the loading of vehicle, such as passenger weight, cargo weight, battery weight, accessory weight, or other weight on vehicle 2′. As weight is added to vehicle 2, 2′, the Center of Gravity may shift forward (e.g., CG2) or rearward (e.g., CG3). In embodiments, controller 50 may be configured to bias power between the first powertrain (e.g., powertrain 20, 40) and the second powertrain (e.g., powertrain 30) based upon the position of the Center of Gravity. In various embodiments, if the Center of Gravity is positioned more rearwardly than CG1, controller 50 may provide more power to the rear axle (i.e., powertrain 30). In various embodiments, if the Center of Gravity is positioned more forwardly than CG1, controller 50 may provide more power to the front axle (i.e., powertrain 20 or powertrain 40).

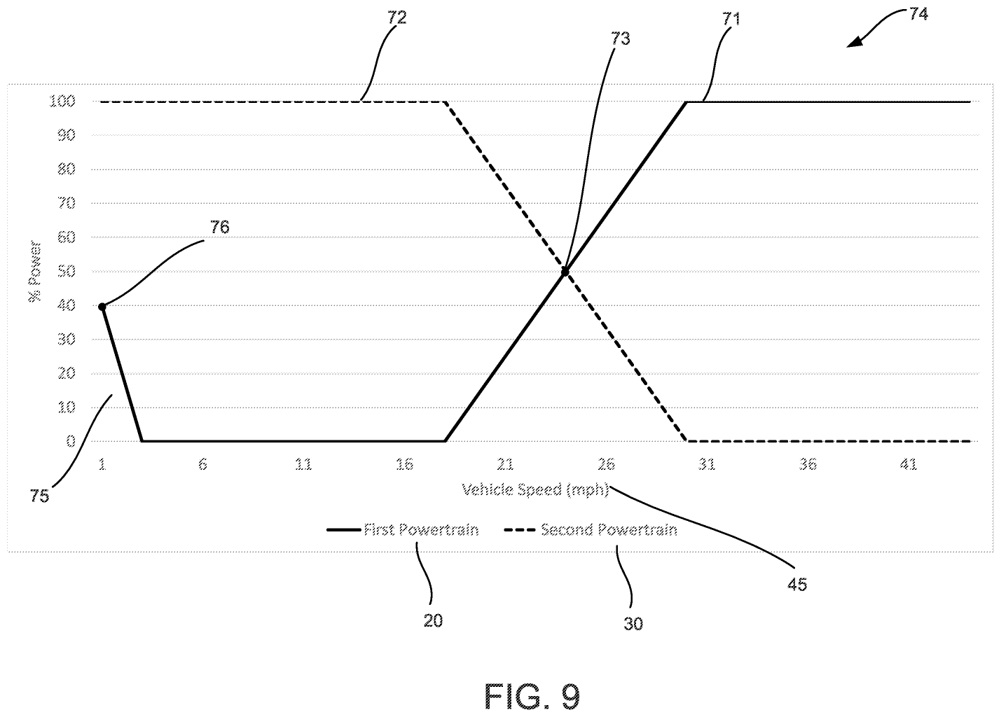

Referring now to FIG. 9, vehicle 2, 2′ may be configured to operate according to a Wear Reducing mode, or a Tire Saving mode, which may operate to reduce wear on one or more of ground engaging members 4, 5, 6, 7. Tire Saving mode may be configured to operate both powertrains according to a certain duty cycle to prevent or reduce tire spin or tire wear. That is, referring to graph 74, from a standstill (i.e., 0 mph), second powertrain 30 may be configured to operate at full power to propel vehicle 2, 2′ with a higher torque, while first powertrain 20 may be configured to operate with power (e.g., at power point 76) for the initial acceleration of vehicle 2, 2′. As vehicle speed 45 increases, first powertrain 20 reduces power output to zero and power may be provided to vehicle 2, 2′ by only second powertrain 30 until vehicle speed 45 increases to transition power output from second powertrain 30 to first powertrain 20. By engaging both first powertrain 20 and second powertrain 30 as vehicle accelerates from a standstill, tire wear is reduced and the life of ground engaging members 4, 5, 6, 7 is increased.

Vehicle 2, 2′ may be configured to operate one or more of powertrains 20, 30, 40 in a variable manner according to a payload present in vehicle 2, 2′. A payload (e.g., passengers, cargo, etc.) may alter the operating characteristics of vehicle 2, 2′. Powertrains 20, 30, 40 are separate and distinct from each other and may be configured to operate according to different operating characteristics during different operating conditions. Controller 50 may be configured to operate one or more of powertrains 20, 30, 40 according to different operating characteristics to accommodate a lighter payload, a heavier payload, and may be configured to accommodate a payload that shifts the center of gravity, shifts more weight forward or backward, or shifts the weight more left or right, all relative to a vehicle center of gravity at a curb weight, or standard weight (i.e., an unloaded vehicle prepared to carry and transit cargo). Controller 50 may be configured to operate one or more of powertrains 20, 30, 40 differently depending upon the payload to operate substantially similar regardless of the vehicle operating conditions.

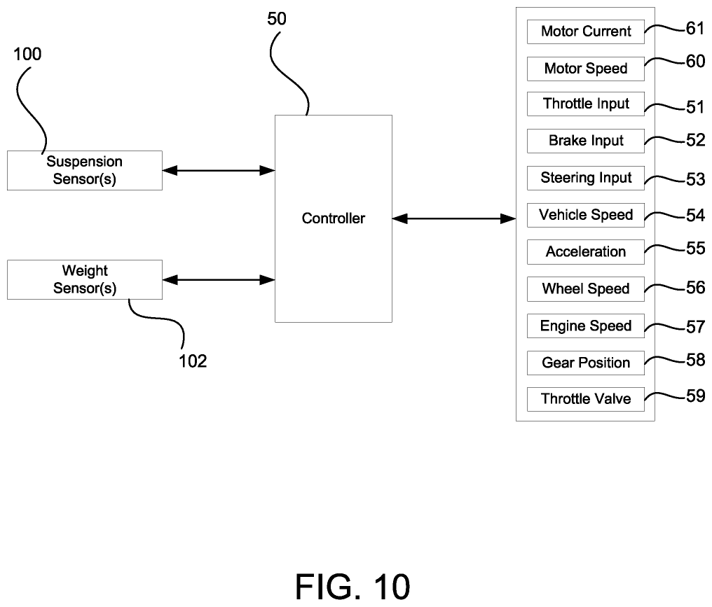

Referring to FIG. 10, vehicle 2, 2′ may experience variable loads which may include variable load sizes or variable load placement within vehicle 2, 2′. Controller 50 may be operably coupled to one or more suspension sensors 100 which may be configured to determine a suspension characteristic. Suspension sensors 100 may be operably coupled to one or more ground engaging members, including ground engaging members 4, 6. In embodiments, each ground engaging member of vehicle 2 includes a suspension sensor 100. In embodiments, suspension sensor 100 is configured to measure a displacement of the suspension (not shown) of vehicle 2. In embodiments, suspension sensor 100 is configured to measure the displacement of a shock absorber, leaf spring, or other type of force-absorbing element. In embodiments, suspension sensor 100 is a force sensor configured to determine a force imparted on a suspension member or a ground engaging member. That is, the one or more suspension sensors are configured to determine the load in vehicle 2, 2′. Controller 50 is configured to determine, based upon the at least one or more suspension sensors how much additional weight is present in vehicle 2, 2′. In embodiments, a suspension sensor 100 may be placed at each corner of vehicle 2, 2′ to determine a placement of the additional weight. In embodiments, controller 50 is operably coupled to one or more weight sensors 102, or force sensors 102, which may be configured to determine how much additional weight is present in vehicle 2, 2′ and may be configured to determine the placement of additional weight. Weight sensors 102 may include plates within cargo portion 11 or other sensors configured to measure the weight of cargo, passengers, or other items/people.

Still referring to FIG. 10, controller 50 may be configured to receive information from one or more of suspension sensor(s) 100 and weight sensor(s) 102 and determine if one or more vehicle parameters may be altered to accommodate the variable weight in vehicle 2, 2′. Vehicle parameters may include motor current 61, motor speed 60, throttle input 51, brake input 52, steering input 53, vehicle speed 54, acceleration 55, wheel speed 56, engine speed 57, gear position 58, or throttle valve position 59. In embodiments, controller 50 may determine that one or more of suspension sensor(s) 100 and weight sensor(s) 102 indicate an increased weight in vehicle 2, 2′ (e.g., increased payload in cargo portion 11) and controller 50 may provide instructions to increase the motor current 61 to increase the motor torque, or overall vehicle torque, to provide better acceleration to vehicle 2, 2′ in response to the increased payload. In embodiments, controller 50 may determine that one or more of suspension sensor(s) 100 and weight sensor(s) 102 indicate a decreased weight in vehicle 2, 2′ (e.g., decreased payload in cargo portion 11) and controller 50 may provide instructions to decrease the motor current 61 to decrease the motor torque to provide better efficiency in response to the increased payload. In embodiments, controller 50 may determine that one or more of suspension sensor(s) 100 and weight sensor(s) 102 indicate an increased weight in vehicle 2, 2′ (e.g., increased payload in cargo portion 11) and controller 50 may provide instructions to increase a brake gain to increase the braking power provided to ground engaging members 4, 5, 6, 7, to provide a generally consistent braking distance to vehicle 2, 2′ in response to the increased payload. In embodiments, controller 50 may determine that one or more of suspension sensor(s) 100 and weight sensor(s) 102 indicate a decreased weight in vehicle 2, 2′ (e.g., decreased payload in cargo portion 11) and controller 50 may provide instructions to decrease a brake gain to decrease the braking power provided to ground engaging members 4, 5, 6, 7, to provide a generally consistent braking distance to vehicle 2, 2′ in response to the decreased payload. Altering vehicle operating characteristics in response to a variable weight allows vehicle 2, 2′ to handle the payload in an appropriate manner and will also allow the various components on vehicle 2, 2′ to wear more evenly and increase the life of the various components (e.g., brakes, tires, etc.) which also increases the uptime of vehicle 2, 2′ by reducing maintenance time and costs.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A driveline for a cargo vehicle, comprising:
a plurality of ground engaging members comprising a front left ground engaging member, a front right ground engaging member, a rear left ground engaging member and a rear right ground engaging member;
a first motor;
a first power source electrically coupled to the first motor;
a non-driven axle coupled between the rear left ground engaging member and the rear right ground engaging member;
a second motor operably coupled to the rear left ground engaging member;
a third motor operably coupled to the rear right ground engaging member; and
a second power source electrically coupled to each of the second motor and the third motor.

2. The driveline of claim 1, further comprising a driven axle coupled between the front left ground engaging member and the front right ground engaging member, the first motor operably coupled to drive the driven axle.

3. The driveline of claim 2, further comprising a powered accessory electrically coupled to the second power source.

4. The driveline of claim 1, wherein the first power source and the second power source are chemically distinct.

5. The driveline of claim 1, further comprising a controller communicably coupled to each of the first motor, the second motor, and the third motor, and the controller is configured to provide instructions to:
operate the first motor when a first vehicle condition is satisfied;
operate the second motor and third motor when a second vehicle condition is satisfied; and
operate each of the first motor, second motor, and third motor when a third vehicle condition is satisfied.

6. The driveline of claim 5, wherein the first vehicle condition is a first wheel speed, the second vehicle condition is a second wheel speed, and the third vehicle condition is a third wheel speed, and the first wheel speed is greater than the third wheel speed, and the third wheel speed is greater than the second wheel speed.

7. A driveline for a cargo vehicle, comprising:
a plurality of ground engaging members comprising a front left ground engaging member, a front right ground engaging member, a rear left ground engaging member and a rear right ground engaging member;
a first motor configured to power each of the front left ground engaging member and the front right ground engaging member;
a first power source electrically coupled to the first motor;
a second motor operably coupled to the rear left ground engaging member;
a third motor operably coupled to the rear right ground engaging member;
an accessory system supported by the frame; and
a second power source supported by the frame, the second power source electrically coupled to each of the second motor, the third motor and the accessory system.

8. The driveline of claim 7, wherein the second motor and the third motor are hub motors.

9. The driveline of claim 7, wherein the front left ground engaging member and the front right ground engaging members are coupled by a driven axle and the rear left ground engaging member and the rear right ground engaging member are coupled by a non-driven axle.

10. The driveline of claim 7, further comprising a controller communicably coupled to each of the first motor, the second motor, and the third motor, and the controller is configured to provide instructions to each of the first motor, second motor and the third motor, the instructions comprising:
operating the first motor after a first threshold value is reached; and
operating the second motor and the third motor before the first threshold value is reached.

11. The driveline of claim 10, wherein the second motor and third motor are configured to provide greater torque than the first motor.

12. The driveline of claim 7, further comprising a controller communicably coupled to each of the first motor, the second motor, and the third motor, and the controller is configured to provide instructions to each of the first motor, second motor and the third motor, the instructions comprising:
operating only the second motor and the third motor during an acceleration vehicle event.

13. The driveline of claim 7, wherein the first power source and the second power source are chemically distinct.

14. A method of retrofitting a cargo vehicle with a secondary powertrain, comprising:
providing, at a first time, the cargo vehicle with a plurality of ground engaging members, a driven axle coupled between the a first ground engaging member of the plurality of ground engaging members and a second ground engaging member of the plurality of ground engaging members, and a non-driven axle coupled between a third ground engaging member of the plurality of ground engaging members and a fourth ground engaging member of the plurality of ground engaging members, a first motor operatively coupled to the driven axle, a first power source electrically coupled to the first motor, and a frame supported by the driven axle and the non-driven axle;
providing, subsequent to the first time, a second motor to the cargo vehicle;
providing, subsequent to the first time, a third motor to the cargo vehicle;
providing, subsequent to the first time, a second power source electrically coupled to the second motor and the third motor;
providing, subsequent to the first time, a controller communicably coupled to each of the first motor, second motor, and third motor;
coupling the second motor to the third ground engaging member; and
coupling the third motor to the fourth ground engaging member.

15. The method of claim 14, further comprising:
providing an accessory system to the cargo vehicle; and
electrically coupling, subsequent to the first time, the accessory system to the second power source.

16. The method of claim 14, further comprising:
providing a controller communicably coupled to the first motor;
communicably coupling, subsequent to the first time, the second motor and the controller;
communicably coupling, subsequent to the first time, the third motor and the controller, and the controller is configured to:
operate the first motor when a first vehicle condition is satisfied;
operate the second motor and third motor when a second vehicle condition is satisfied; and
operate each of the first motor, second motor, and third motor when a third vehicle condition is satisfied.

17. The method of claim 14, wherein the first motor is an electric motor, the second motor is a hub motor, and the third motor is a hub motor.

18. The method of claim 14, wherein the second power source and first power source are chemically distinct.

19. The method of claim 14, wherein the first motor is an internal combustion engine and the second motor is a hub motor and the third motor is a hub motor.
